(19) United States
(12) Patent Application Publication
(10) Pub. No.: US 2006/0168636 A1
(43) Pub. Date: Jul. 27, 2006

(54) Apparatus and method for storing signals and for distributing them by down-converting to vacant channels

(75) Inventors: Michael Anthony Pugel, Noblesville, IN (US); Douglas Edward Lankford, Carmel, IN (US); John Joseph Curtis III, Noblesville, IN (US); Keith Reynolds Wehmeyer, Fishers, IN (US); Mike Arthur Derrenberger, Fishers, IN (US); Terry Wayne Lockridge, Dayton, OH (US); Andrew Eric Bowyer, Indianapolis, IN (US)

Correspondence Address: THOMSON LICENSING INC., PATENT OPERATIONS, PO BOX 5312, PRINCETON, NJ, 08543-5312, US

(73) Assignee: THOMSON LICENSING S.A., Boulogne (FR)

(21) Appl. No.: 10/548,926

(22) PCT Filed: Mar. 9, 2004
(86) PCT No.: PCT/US04/07113

§ 371 Date: Sep. 12, 2005

Related U.S. Application Data
(60) Provisional application No. 60/453,763, filed on Mar. 11, 2003.
(60) Provisional application No. 60/453,491, filed on Mar. 11, 2003.

(51) Int. Cl. H04N 7/173; H04N 7/16; H04N 5/38

(52) U.S. Cl. 725/114; 348/723; 725/144; 725/116; 725/146

(57) ABSTRACT

A server apparatus is capable of distributing recorded content in a household and/or business dwelling using the existing coaxial cable infrastructure. According to an exemplary embodiment, the server apparatus includes a front-end processor operative to receive signals from a broadcast source and process the received signals to generate digital data. A memory is operative to record the digital data. A controller is operative to enable retrieval of the digital data from the memory. An encoder is operative to encode the retrieved digital data with error correction data to generate encoded digital signals. A digital-to-analog converter is operative to convert the encoded digital signals to analog signals. A modulator is operative to modulate the analog signals to generate processed analog signals, which are provided to a client device via a coaxial cable connecting the server apparatus and the client device.

### CROSS REFERENCE TO RELATED APPLICATION

This application claims priority to and all benefits accruing from two provisional applications filed in the United States Patent and Trademark Office on Mar. 11, 2003, and having respectively assigned Ser. Nos. 60/453,491 and 60/453,763.

### BACKGROUND OF THE INVENTION

1. Field of the Invention

The present invention generally relates to the distribution of recorded content such as audio, video and/or data signals, and more particularly, to an apparatus and method capable of distributing such recorded content in a household and/or business dwelling using the existing coaxial cable infrastructure.

2. Background Information

In a satellite broadcast system, a satellite receives signals representing audio, video, and/or data information from an earth-based transmitter. The satellite amplifies and rebroadcasts these signals to a plurality of receivers, located at the dwellings of consumers, via transponders operating at specified frequencies and having given bandwidths. Such a system includes an uplink transmitting portion (i.e., earth to satellite), an earth-orbiting satellite receiving and transmitting portion, and a downlink portion (i.e., satellite to earth) including one or more receivers located at the dwellings of consumers.

For dwellings that receive signals via systems such as a satellite broadcast system, the distribution of received signals in the dwelling, including received signals recorded by a receiver, can be a difficult proposition. For example, many existing dwellings are equipped with coaxial cable such as RG-59 type coaxial cable, which is not readily conducive for distributing certain signals such as satellite broadcast signals or recorded signals. One reason coaxial cable such as RG-59 is not used to distribute such signals in a dwelling is that the coaxial cable may already be used for distributing cable broadcast signals. Accordingly, it may be difficult for such signals to co-exist with cable broadcast signals on the coaxial cable given its limited bandwidth. Another reason that coaxial cable such as RG-59 is not used to distribute certain signals in a dwelling is that the coaxial cable may use a portion of the frequency spectrum that is different than the frequencies occupied by the signals to be distributed. For example, signals such as satellite broadcast signals may occupy a portion of the frequency spectrum (e.g., greater than 1 GHz) which is higher than the signal frequencies that can be readily distributed over coaxial cable such as RG-59 and its associated signal splitters and/or repeaters (e.g., less than 860 MHz).

Heretofore, the issue of recording signals such as satellite broadcast signals and distributing the recorded signals in a dwelling using the existing coaxial cable infrastructure (e.g., RG-59) has not been adequately addressed. While certain technologies (e.g., IEEE 1394) may be used for signal distribution within a dwelling, such technologies typically require a dwelling to be re-wired, which may be cost-prohibitive for most consumers. Moreover, existing wireless technologies may not be suitable for distributing certain types of signals, such as video signals, within a dwelling.

Accordingly, there is a need for an apparatus and method, which avoids the foregoing problems, and thereby enables signals such as audio, video, and/or data signals to be recorded and distributed in a household and/or business dwelling using the existing coaxial cable infrastructure.

### SUMMARY OF THE INVENTION

In accordance with an aspect of the present invention, a server apparatus is disclosed. According to an exemplary embodiment, the server apparatus comprises processing means for receiving signals from a broadcast source and processing the received signals to generate digital data. Memory means record the digital data. Control means enable retrieval of the digital data from the memory means. Encoding means encode the retrieved digital data with error correction data to generate encoded digital signals. Digital-to-analog converting means convert the encoded digital signals to analog signals. Modulating means modulate the analog signals to generate processed analog signals, which are provided to a client device via a coaxial cable connecting the server apparatus and the client device.

In accordance with another aspect of the present invention, a method for distributing signals from a server apparatus to a client device is disclosed. According to an exemplary embodiment, the method comprises steps of receiving signals from a broadcast source, generating digital data responsive to the received signals, recording the digital data to a storage medium, retrieving the digital data from the storage medium, encoding the retrieved digital data with error correction data to generate encoded digital signals, converting the encoded digital signals to analog signals, modulating the analog signals to generate processed analog signals, and providing the processed analog signals to the client device via a coaxial cable connecting the server apparatus and the client device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of an exemplary environment suitable for implementing the present invention;

FIG. 2 is a block diagram of the server apparatus of FIG. 1 according to an exemplary embodiment of the present invention;

FIG. 3 is a block diagram of one of the client devices of FIG. 1 according to an exemplary embodiment of the present invention; and

FIG. 4 is a flowchart illustrating steps according to an exemplary embodiment of the present invention.

The exemplifications set out herein illustrate preferred embodiments of the invention, and such exemplifications are not to be construed as limiting the scope of the invention in any manner.

### DETAILED DESCRIPTION

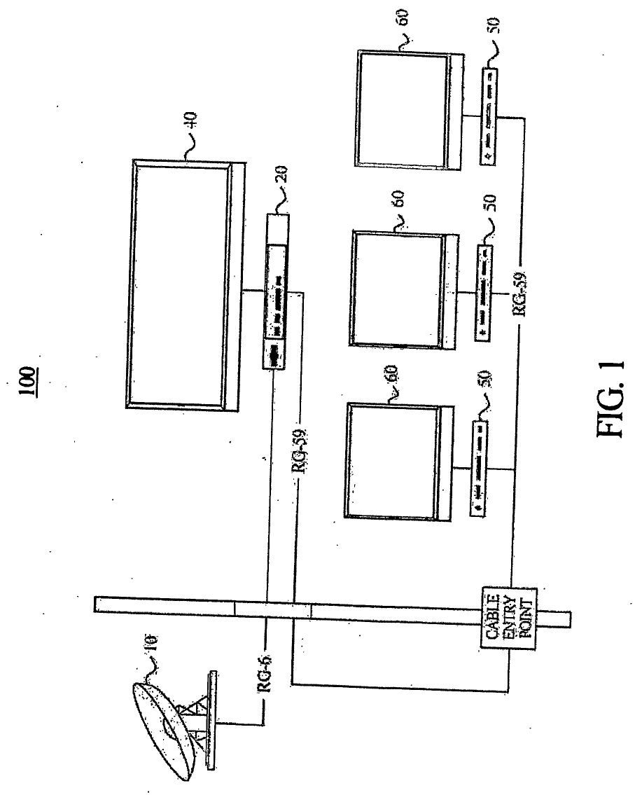

Referring now to the drawings, and more particularly to FIG. 1, an exemplary environment 100 suitable for implementing the present invention is shown. In FIG. 1, environment 100 comprises a signal receiving element 10, a server apparatus 20 having a local output device 40, and client devices 50 each having an associated local output device 60. According to an exemplary embodiment, signal receiving element 10 is operatively coupled to server apparatus 20 via a coaxial cable connection comprised of RG-6 type coaxial cable, and server apparatus 20 is operatively coupled to each client device 50 via a coaxial cable connection comprised of RG-59 type coaxial cable. Other transmission media such as other types of coaxial cable, optical fibers, and air may also be used according to the present invention. Although not expressly shown in FIG. 1, environment 100 may also include elements such as signal splitters and/or repeaters. Environment 100 may for example represent a signal distribution network within a given household and/or business dwelling.

Signal receiving element 10 is operative to receive signals including audio, video, and/or data signals from one or more signal sources, such as a satellite broadcast system and/or other systems such as a digital terrestrial broadcast system. According to an exemplary embodiment, signal receiving element 10 is embodied as an antenna such as a satellite receiving dish, but may also be embodied as any type of signal receiving element such as an input terminal and/or other element.

Server apparatus 20 is operative to receive signals including audio, video, and/or data signals from signal receiving element 10, process the received signals to generate processed analog signals, and distribute the processed analog signals to local output device 40 and/or client devices 50. According to an exemplary embodiment, local output device 40 is operative to provide aural and/or visual outputs corresponding to processed analog signals provided from server apparatus 20, and may be embodied as an analog and/or digital device such as for example a standard-definition (SD) and/or high-definition (HD) television signal receiver. Also according to an exemplary embodiment, each client device 50 is operative to receive and process the processed analog signals provided from server apparatus 20 to thereby enable corresponding aural and/or visual outputs via its associated local output device 60. Each local output device 60 may be embodied as an analog and/or digital device such as an SD and/or HD television signal receiver. Further exemplary details regarding client devices 50 will be provided later herein.

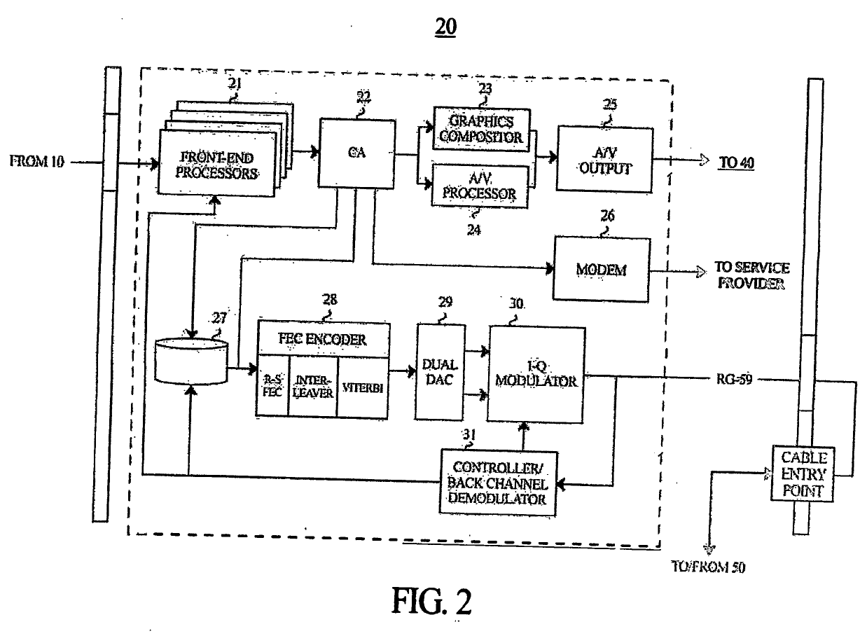

Referring to FIG. 2, a block diagram of server apparatus 20 of FIG. 1 according to an exemplary embodiment of the present invention is shown. In FIG. 2, server apparatus 20 comprises front-end processing means such as front-end processors 21, conditional access (CA) means such as CA module 22, graphics compositing means such as graphics compositor 23, audio/video (A/V) processing means such as A/V processor 24, A/V output means such as A/V output 25, modulating/demodulating means such as modem 26, memory means such as memory 27, encoding means such as forward error correction (FEC) encoder 28, digital-to-analog converting means such as dual digital-to-analog converter (DAC) 29, modulating means such as I-Q modulator 30, and controlling/demodulating means such as controller/back channel demodulator 31. The foregoing elements of FIG. 2 may be embodied using integrated circuits (ICs), and any given element may for example be included on one or more ICs. For clarity of description, certain conventional elements associated with server apparatus 20 such as certain control signals, power signals and/or other elements may not be shown in FIG. 2.

Front-end processors 21 are operative to perform various front-end processing functions of server apparatus 20. According to an exemplary embodiment, front-end processors 21 are each operative to perform processing functions including channel tuning, analog-to-digital (A/D) conversion, demodulation, FEC decoding, and de-multiplexing functions. According to an exemplary embodiment, the channel tuning function of each front-end processor 21 may convert satellite broadcast signals from a relatively high frequency band (e.g., greater than 1 GHz) to baseband signals. As referred to herein, the term “baseband” may refer to signals, which are at, or near, a baseband level. The tuned baseband signals are converted to digital signals, which are demodulated to generate demodulated digital signals. According to an exemplary embodiment, each front-end processor 21 may be operative to demodulate various types of signals such as Quadrature Amplitude Modulated (QAM) signals, Phase Shift Keyed (PSK, e.g., QPSK) signals, and/or signals having other types of modulation. The FEC decoding function is applied to the demodulated digital signals to thereby generate error corrected digital signals. According to an exemplary embodiment, the FEC decoding function of each front-end processor 21 may include Reed-Solomon (R-S) FEC, de-interleaving, Viterbi and/or other functions. The error corrected digital signals may include a plurality of time-division multiplexed broadcast programs, and are de-multiplexed into one or more digital transport streams. For purposes of example and explanation, server apparatus 20 of FIG. 2 includes four front-end processors 21 (i.e., one for local output device 40, and one for each client device 50). In practice, however, the number of front-end processors 21 may be a matter of design choice. For example, the number of front-end processors 21 may vary depending upon the number of coaxially connected client devices 50 serviced by server apparatus 20. Accordingly, there may be “N+1” front-end processors 21 for “N” client devices 50, where “N” is an integer.

CA module 22 is operative to perform a CA function of server apparatus 20 by decrypting the digital transport streams provided from front-end processors 21 to thereby generate decrypted digital transport streams. According to an exemplary embodiment, CA module 22 may include a smart card and/or other elements, which enable the CA function.

Graphics compositor 23 is operative to perform graphics compositing functions of server apparatus 20, which enable graphical displays via local output device 40. According to an exemplary embodiment, graphics compositor 23 generates analog and/or digital signals, which represent graphical displays such as user interfaces (UIs), which allow users to interact with server apparatus 20 and/or client devices 50.

A/V processor 24 is operative to perform various A/V processing functions of server apparatus 20, which enable aural and/or visual outputs via local output device 40. According to an exemplary embodiment, A/V processor 24 is operative to process the decrypted digital transport streams provided from CA module 22 by performing functions including Motion Picture Expert Group (MPEG) decoding, National Television Standards Committee (NTSC) or other type of encoding, and digital-to-analog (D/A) conversion functions to thereby generate analog baseband signals. In this manner, the decrypted digital transport stream provided from CA module 22 may be MPEG decoded to generate decoded signals. The decoded signals may then be encoded as NTSC signals or other types of signals (e.g., PAL, SECAM, VSB, QAM, etc.), and converted to analog signals. In the event local output device 40 is a digital device such as a digital television signal receiver, the aforementioned encoding and/or D/A functions may be bypassed.

A/V output 25 is operative to perform an A/V output function of server apparatus 20 by enabling output of the analog and/or digital signals provided from graphics compositor 23 and/or A/V processor 24 to local output device 40. According to an exemplary embodiment, A/V output 25 may be embodied as any type of A/V output means such as any type of wired and/or wireless output terminal.

Modem 26 is operative to provide signals representing information such as billing, pay-per-view, and/or other information to a service provider. According to an exemplary embodiment, modem 26 may be coupled to a transmission medium such as a telephone line, and may be programmed to provide such information to the service provider in accordance with a predetermined schedule (e.g., every other Tuesday at 2:00 am, etc.).

Memory 27 is operative to record digital data including the decrypted digital transport streams provided from CA module 22. According to an exemplary embodiment, the digital data recorded in memory 27 may be accessed by any of the client devices 50 via the coaxial cable connecting server apparatus 20 and client devices 50. For example, client devices 50 may be provided with an electronic program guide (EPG) or other directory, which describes (e.g., by program name, time of recording, etc.) the digital data recorded in memory 27. Server apparatus 20 may distribute this EPG or directory to client devices 50 via the coaxial cable on a periodic basis to apprise users of the digital data currently stored in memory 27. In this manner, users may interact with the EPG or directory to select digital data to be retrieved and distributed to client device(s) 50 via the coaxial cable. Memory 27 may be embodied as any type of suitable storage medium such as a hard disk drive (HDD), digital versatile disk (DVD), and/or other data storage medium.

FEC encoder 28 is operative to encode the digital data provided from CA module 22 and memory 27 with error correction data to thereby generate encoded digital signals. According to an exemplary embodiment, FEC encoder 28 is operative to encode the decrypted digital transport streams by performing functions including R-S FEC, data interleaving, Viterbi and/or other functions.

Dual DAC 29 is operative to convert the encoded digital signals provided from FEC encoder 28 to analog baseband signals. According to an exemplary embodiment, dual DAC 29 generates the analog baseband signals as separate I (i.e., in-phase) and Q (i.e., quadrature) signals.

I-Q modulator 30 is operative to modulate the I and Q analog baseband signals provided from dual DAC 29 to thereby generate processed analog signals which may be provided to one or more client devices 50 via the coaxial cable connecting server apparatus 20 and client devices 50. I-Q modulator 30 may perform functions including frequency upconversion, quadrature combining, filtering, and/or other functions. According to an exemplary embodiment, I-Q modulator 30 modulates the analog baseband signals responsive to one or more control signals provided from controller 31. Such control signals cause I-Q modulator 30 to modulate the analog baseband signals to one or more available frequency bands on the coaxial cable which may be used to provide the processed analog signals from server apparatus 20 to one or more client devices 50. According to an exemplary embodiment, I-Q modulator 30 modulates the analog baseband signals to radio frequency (RF) bands, which are less than 1 GHz.

According to an alternative embodiment, dual DAC 29 and I-Q modulator 30 may be replaced by a single DAC and an RF modulator (not shown in FIG. 2). With this alternative embodiment, an I-Q modulation function may be incorporated into FEC encoder 28 which would produce baseband encoded digital signals. The single DAC would convert the baseband encoded digital signals to analog signals. The RF modulator would then RF modulate the analog signals to one or more available frequency bands on the coaxial cable for delivery to one or more client devices 50.

Controller/back channel demodulator 31 is operative to perform data retrieval functions, control functions and back channel demodulation functions of server apparatus 20. According to an exemplary embodiment, controller 31 performs a data retrieval function by generating one or more control signals, which enable digital data to be retrieved from memory 27. Also, according to an exemplary embodiment, controller 31 is operative to detect one or more available frequency bands on the coaxial cable, which may be used to provide the processed analog signals from server apparatus 20 to one or more client devices 50. Based on this detection, controller 31 generates one or more control signals, which control I-Q modulator 30, as previously described herein.

According to an exemplary embodiment, controller 31 dynamically scans a plurality of frequency bands on the coaxial cable to thereby detect the one or more available frequency bands. The controller 31 may detect an available frequency band by measuring the signal power in that frequency band. If the signal power of a frequency band is below a threshold, the controller 31 determines that the frequency band is available. According to another exemplary embodiment, controller 31 may detect the one or more available frequency bands on the coaxial cable based on a user input. For example, a user may interact with server apparatus 20 via an on-screen UI provided via local output device 40 and/or one or more client devices 50 which enables the user to select one or more frequency bands on the coaxial cable to be used for signal transmission between server apparatus 20 and client devices 50. In this manner, the user may cause certain frequency bands on the coaxial cable to be dedicated (i.e., “notched out”) for signal transmission between server apparatus 20 and client devices 50.

Also, according to an exemplary embodiment, back channel demodulator 31 is operative to demodulate request signals provided from client devices 50 via the coaxial cable, which may be used as a back channel. Such request signals may control various functions of server apparatus 20, such as the aforementioned data retrieval function and a channel tuning function. For example, a demodulated request signal generated by back channel demodulator 31 may cause controller 31 to generate a corresponding control signal, which enables certain digital data (e.g., a broadcast program) to be stored and/or retrieved from memory 27. A demodulated request signal generated by back channel demodulator 31 may also cause controller 31 to generate a corresponding control signal, which controls the channel tuning function via front-end processors 21.

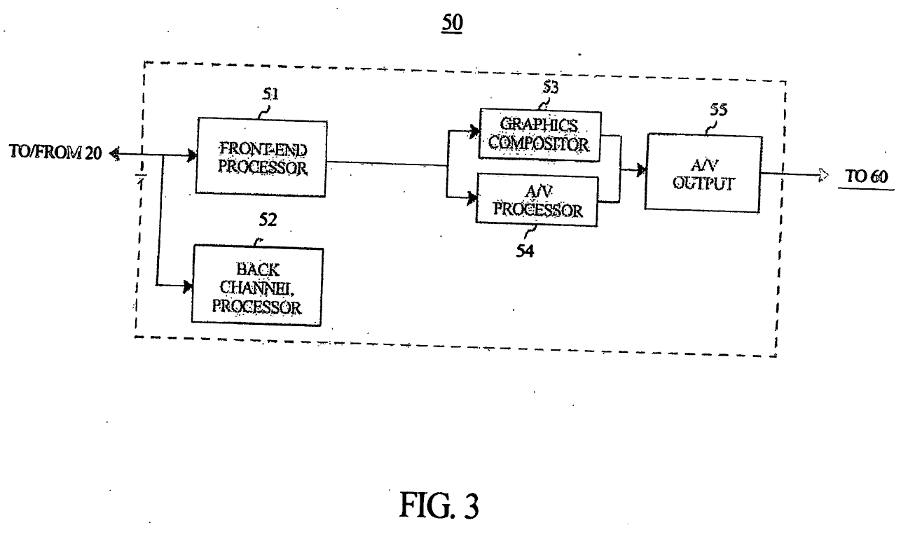

Referring to FIG. 3, a block diagram of one of the client devices 50 of FIG. 1 according to an exemplary embodiment of the present invention is shown. In FIG. 3, client device 50 comprises front-end processing means such as front-end processor 51, back channel processing means such as back channel processor 52, graphics compositing means such as graphics compositor 53, A/V processing means such as A/V processor 54, and A/V output means such as A/V output 55. The foregoing elements of FIG. 3 may be embodied using ICs, and any given element may for example be included on one or more ICs. For clarity of description, certain conventional elements associated with client device 50 such as certain control signals, power signals and/or other elements may not be shown in FIG. 3.

Front-end processor 51 is operative to perform various front-end processing functions of client device 50. According to an exemplary embodiment, front-end processor 51 is operative to perform processing functions including channel tuning, A/D conversion, demodulation, FEC decoding, and de-multiplexing functions. According to an exemplary embodiment, the channel tuning function of front-end processor 51 converts the processed analog signals provided via the coaxial cable from server apparatus 20 to baseband signals. The tuned baseband signals are converted to digital signals, which are demodulated to generate demodulated digital signals. According to an exemplary embodiment, front-end processor 51 may be operative to demodulate various types of signals such as QAM signals, QPSK signals, and/or signals having other types of modulation. The FEC decoding function is applied to the demodulated digital signals to thereby generate error corrected digital signals. According to an exemplary embodiment, the FEC decoding function of front-end processor 51 may include R-S FEC, de-interleaving, Viterbi and/or other functions. The error corrected digital signals may include a plurality of time-division multiplexed broadcast programs, and are de-multiplexed into one or more digital transport streams.

Back channel processor 52 is operative to perform various back channel processing functions of client device 50. According to an exemplary embodiment, back channel processor 52 is operative to generate request signals responsive to user inputs to client device 50, and such request signals may be used to control server apparatus 20. For example, back channel processor 52 may generate a request signal responsive to a user input which requests that server apparatus 20 record certain data (e.g., a particular broadcast program) in memory 27. As another example, back channel processor 52 may generate a request signal responsive to a user input which requests that certain recorded data (e.g., a recorded broadcast program) in memory 27 of server apparatus 20 be retrieved and provided to client device 50 via the coaxial cable connecting server apparatus 20 and client devices 50. As yet another example, back channel processor 52 may generate a request signal responsive to a user input which requests that server apparatus 20 tune to a particular channel and provide signals from that channel to client device 50 via the coaxial cable connecting server apparatus 20 and client devices 50. A given request signal may include various types of information, which may be matter of design choice. For example, request signals may include information, which identifies data or signals based on corresponding digital transport stream(s). In the event that server apparatus 20 is receiving signals from a satellite broadcast system, the request signal may also include information indicating a particular transponder, which provides the digital transport stream(s). Other types of information may also be included in the request signal.

Also, according to an exemplary embodiment, back channel processor 52 is operative to detect one or more available frequency bands on the coaxial cable, which may be used to provide the request signals from client device 50 to server apparatus 20. According to an exemplary embodiment, back channel processor 52 may detect the one or more available frequency bands on the coaxial cable in the same manner as controller 31 of server apparatus 20. In particular, back channel processor 52 may dynamically scan a plurality of frequency bands on the coaxial cable to thereby detect the one or more available frequency bands, and/or may detect the one or more available frequency bands on the coaxial cable based on a user input, which selects the one or more available frequency bands.

According to a first exemplary embodiment, back channel processor 52 may also control the channel tuning function of front-end processor 51. For example, back channel processor 52 may include in a request to gateway apparatus 20 one of the available frequency bands it has dynamically detected or a frequency band selected by a user, and signal front-end processor 51 to tune that available frequency band or the frequency band selected by the user.

According to a second exemplary embodiment, back channel processor 52 may include all the available frequency bands in a request, and gateway apparatus 20 selects one of the available frequency bands to provide broadcast signals from a channel selected by a user. In the second exemplary embodiment, back channel processor 52 may dynamically scan a plurality of frequency bands on the coaxial cable after a request signal is provided to gateway apparatus 20 in order to detect a desired digital transport stream provided from gateway apparatus 20. According to this second exemplary embodiment, back channel processor 52 may process signals from the plurality of frequency bands to thereby detect a desired digital transport stream. For example, back channel processor 52 may detect program identification information in the signals from the plurality of frequency bands to thereby detect a desired digital transport stream. Once a desired digital transport stream is detected, back channel processor 52 may provide a control signal to front-end processor 51, which causes the front-end processor 51 to tune the particular frequency band on the coaxial cable that provides the desired digital transport stream.

In a third exemplary embodiment, back channel processor 52 does not include a frequency band in a request and gateway apparatus must detect an available frequency band to provide broadcast signals from a channel selected by the user. In this third exemplary embodiment, back channel should detect a desired digital transport stream and cause front-end processor 51 to tune the particular frequency band on the coaxial cable that provides the desired digital transport stream, as discussed above with respect to the second exemplary embodiment.

Graphics compositor 53 is operative to perform graphics compositing functions of client device 50, which enable graphical displays via local output device 60. According to an exemplary embodiment, graphics compositor 53 generates analog and/or digital signals, which represent graphical displays such as user interfaces (UIs), which allow users to interact with server apparatus 20 and/or client devices 50.

A/V processor 54 is operative to perform various A/V processing functions of client device 50. According to an exemplary embodiment, A/V processor 54 is operative to perform functions including MPEG decoding, NTSC or other type of encoding, and D/A conversion functions. In this manner, the digital transport stream provided from front-end processor 51 may be MPEG decoded to generate decoded signals. The decoded signals may then be encoded as NTSC signals or other types of signals (e.g., PAL, SECAM, VSB, QAM, etc.), and converted to analog signals. In the event local output device 60 is a digital device such as a digital television signal receiver, the aforementioned encoding and/or D/A functions may be bypassed.

A/V output 55 is operative to perform an A/V output function of client device 50 by enabling output of the analog and/or digital signals provided from graphics compositor 53 and/or A/V processor 54 to local output device 60. According to an exemplary embodiment, A/V output 55 may be embodied as any type of A/V output means such as any type of wired and/or wireless output terminal.

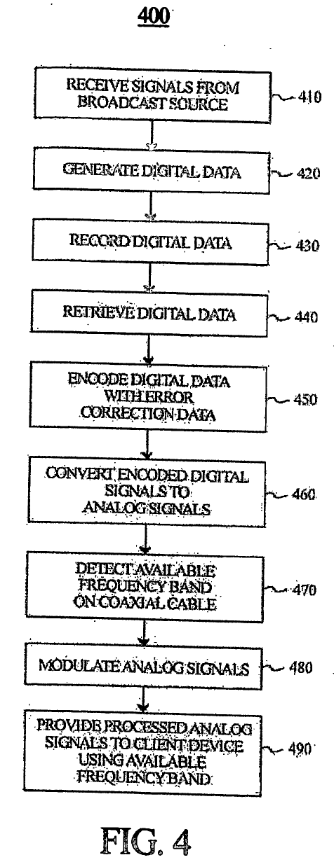

To facilitate a better understanding of the inventive concepts of the present invention, an example will now be provided. Referring to FIG. 4, a flowchart 400 illustrating steps according to an exemplary embodiment of the present invention is shown. For purposes of example and explanation, the steps of FIG. 4 will be described with reference to the previously described elements of environment 100 of FIG. 1. The steps of FIG. 4 are merely exemplary, and are not intended to limit the present invention in any manner.

At step 410, server apparatus 20 receives signals provided from a broadcast source. According to an exemplary embodiment, server apparatus 20 receives via signal receiving element 10 signals such as audio, video, and/or data signals from one or more signal sources, such as a satellite broadcast system and/or other systems such as a digital terrestrial broadcast system.

At step 420, server apparatus 20 generates digital data responsive to the received broadcast signals. According to an exemplary embodiment, the digital data is generated at step 420 as one or more digital transport streams via one or more front-end processors 21 using the previously described channel tuning, A/D conversion, demodulation, FEC decoding, and de-multiplexing functions.

At step 430, server apparatus 20 records the digital data generated at step 420 to memory 27. According to an exemplary embodiment, the digital data generated at step 420 is decrypted by CA module 22 and may be recorded to memory 27 responsive to a user input to server apparatus 20 and/or client devices 50.

At step 440, server apparatus 20 retrieves digital data from memory 27. According to an exemplary embodiment, digital data may be retrieved from memory 27 at step 440 responsive to a request signal provided from a particular client device 50. The request signal may be provided to server apparatus 20 via the coaxial cable connecting server apparatus 20 and client devices 50 where it is demodulated by back channel demodulator 31. The demodulated request signal generated by back channel demodulator 31 may then cause controller 31 to generate a corresponding control signal, which enables certain digital data (e.g., a broadcast program) to be retrieved from memory 27.

At step 450, server apparatus 20 encodes the retrieved digital data with error correction data to thereby generate encoded digital signals. According to an exemplary embodiment, FEC encoder 24 encodes the retrieved digital data at step 450 by performing R-S FEC, data interleaving, Viterbi, and/or other functions.

At step 460, server apparatus 20 converts the encoded digital signals generated at step 450 to analog signals. According to an exemplary embodiment, dual DAC 29 generates the analog signals at step 460 as separate I (i.e., in-phase) and Q (i.e., quadrature) signals.

At step 470, server apparatus 20 detects an available frequency band on the coaxial cable connecting it to client devices 50. As previously indicated herein, controller 31 may dynamically scan a plurality of frequency bands on the coaxial cable to detect the available frequency band at step 470, and/or may detect the available frequency band based on a user input which selects the available frequency band.

At step 480, server apparatus 20 modulates the analog signals generated at step 460 to thereby generate processed analog signals. According to an exemplary embodiment, I-Q modulator 30 modulates the analog signals to the available frequency band on the coaxial cable detected at step 470 responsive to one or more control signals provided from controller 31.

At step 490, server apparatus 20 provides the processed analog signals generated at step 480 to client device 50 using the available frequency band on the coaxial cable detected at step 470. The steps of FIG. 4 may be performed a plurality of times in a simultaneous manner to thereby simultaneously provide processed analog signals to “N” different client devices 50. In this manner, server apparatus 20 may for example distribute “N” different recorded broadcast programs to “N” different client devices 50 in a simultaneous manner.

As described herein, the present invention provides an apparatus and method capable of distributing recorded content such as audio, video, and/or data signals in a household and/or business dwelling using the existing coaxial cable infrastructure. The present invention may be applicable to various apparatuses, either with or without a display device. Accordingly, the phrase “television signal receiver” as used herein may refer to systems or apparatuses including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A server apparatus, comprising:
processing means for receiving broadcast signals and processing said received signals to generate digital data;
memory means for recording said digital data;
control means for enabling retrieval of said digital data from said memory means, wherein said control means further detects an available frequency band on said transmission medium;
encoding means for encoding said retrieved digital data to generate encoded digital signals;
digital-to-analog converting means for converting said encoded digital signals to analog signals; and
modulating means for modulating said analog signals to generate processed analog signals, wherein said processed analog signals are provided to a client device via said transmission medium connecting said server apparatus and said client device, and wherein said available frequency band is used to provide said processed analog signals to said client device, thereby causing said transmission medium to be shared between said processed analog signals and cable broadcast signals distributed over said transmission medium.

2. The server apparatus of claim 1, wherein said transmission medium includes RG-59 cable.

3. The server apparatus of claim 1, wherein said broadcast source includes a satellite source.

4. The server apparatus of claim 1, wherein said broadcast source includes a digital terrestrial source.

5. The server apparatus of claim 1, wherein said memory means includes a hard disk drive.

6. The server apparatus of claim 1, wherein said memory means includes a digital versatile disk.

7. The server apparatus of claim 1, wherein said control means enables retrieval of said digital data from said memory means responsive to a request signal provided from said client device via said transmission medium.

8. The server apparatus of claim 1, wherein said control means scans a plurality of frequency bands on said transmission medium to detect said available frequency band.

9. The server apparatus of claim 1, wherein said control means detects said available frequency band based on a user input which selects said available frequency band.

10. A method for distributing signals from a server apparatus to a client device, comprising steps of:
receiving signals from a broadcast source;
generating digital data responsive to said received signals;
recording said digital data to a storage medium;
retrieving said digital data from said storage medium;
encoding said retrieved digital data to generate encoded digital signals;
converting said encoded digital signals to analog signals;
modulating said analog signals to generate processed analog signals;
detecting an available frequency band on said transmission medium; and
providing said processed analog signals to said client device via a transmission medium connecting said server apparatus and said client device, wherein said available frequency band is used to provide said processed analog signals to said client device, thereby causing said transmission medium to be shared between said processed analog signals and cable broadcast signals distributed over said transmission medium.

11. The method of claim 10, wherein said transmission medium includes RG-59 cable.

12. The method of claim 10, wherein said broadcast source includes a satellite source.

13. The method of claim 10, wherein said broadcast source includes a digital terrestrial source.

14. The method of claim 10, wherein said storage medium includes a hard disk drive.

15. The method of claim 10, wherein said storage medium includes a digital versatile disk.

16. The method of claim 10, wherein said retrieving step is performed responsive to a request signal provided from said client device via said transmission medium.

17. The method of claim 10, wherein said detecting step includes scanning a plurality of frequency bands on said transmission medium to identify said available frequency band.

18. The method of claim 10, wherein said detecting step is performed based on a user input which selects said available frequency band.

19. A server apparatus, comprising:
a front-end processor operative to receive broadcast signals and process said received signals to generate digital data;
a memory operative to record said digital data;
a controller operative to enable retrieval of said digital data from said memory, wherein said controller further detects an available frequency band on a transmission medium;
an encoder operative to encode said retrieved digital data to generate encoded digital signals;
a digital-to-analog converter operative to convert said encoded digital signals to analog signals; and
a modulator operative to modulate said analog signals to generate processed analog signals, wherein said processed analog signals are provided to a client device via said transmission medium connecting said server apparatus and said client device, and wherein said available frequency band is used to provide said processed analog signals to said client device, thereby causing said transmission medium to be shared between said processed analog signals and cable broadcast signals distributed over said transmission medium.

20. The server apparatus of claim 19, wherein said transmission medium includes RG-59 cable.

21. The server apparatus of claim 19, wherein said broadcast source includes a satellite source.

22. The server apparatus of claim 19, wherein said broadcast source includes a digital terrestrial source.

23. The server apparatus of claim 19, wherein said memory includes a hard disk drive.

24. The server apparatus of claim 19, wherein said memory includes a digital versatile disk.

25. The server apparatus of claim 19, wherein said controller enables retrieval of said digital data from said memory responsive to a request signal provided from said client device via said transmission medium.

26. The server apparatus of claim 19, wherein said controller scans a plurality of frequency bands on said transmission medium to detect said available frequency band.

27. The server apparatus of claim 19, wherein said controller detects said available frequency band based on a user input which selects said available frequency band.
